(19) United States
(12) Patent Application Publication
(10) Pub. No.: US 2018/0305175 A1
(43) Pub. Date: Oct. 25, 2018

(54) ELEVATOR MANAGEMENT SYSTEM

(71) Applicants: Gilles BRUNO, Gien (FR); Otis Elevator Company, Farmington, CT (US)

(72) Inventor: Gilles Bruno, Chateauneuf Sur Loire (FR)

(21) Appl. No.: 15/775,543

(22) PCT Filed: Nov. 12, 2015
(86) PCT No.: PCT/IB2015/002261

§ 371 Date: May 11, 2018

(51) Int. Cl. B66B 5/00; B66B 3/00; B66B 1/34

(52) U.S. Cl. CPC B66B 5/0018; B66B 1/3492; B66B 1/3461; B66B 3/002

(57) ABSTRACT

A method and system for managing at least one elevator (102) is disclosed. The method includes storing a plurality of elevator parameter records corresponding to the at least one elevator (102) in an elevator parameter database (110), analyzing the plurality of elevator parameter records via a processor (120), generating a plurality of parameter of interest records contained in a parameter of interest database (140) via the processor (120), and displaying the plurality of parameter of interest records via a user interface (130)

### BACKGROUND

The subject matter disclosed herein relates to management systems, and to a system and a method for managing at least one elevator.

Typically, during the course of elevator operation, operating data is collected. For example, data regarding elevator loads, door status, elevator car position, etc. can be collected. In certain applications, information regarding elevator systems is collected independently in various locations and systems.

Therefore, in order to obtain, review and analyze operating information, it is often required to access multiple systems, which may require multiple logins or trips to physical locations to compile data. A system and method that can provide a centralized elevator management system is desired.

### BRIEF SUMMARY

According to an embodiment, a system for managing at least one elevator includes an elevator parameter database containing a plurality of elevator parameter records corresponding to the at least one elevator, a processor to analyze the plurality of elevator parameter records to generate a plurality of parameter of interest records contained in a parameter of interest database, and a user interface to display the plurality of parameter of interest records.

In addition to one or more of the features described above, or as an alternative, further embodiments could include that the processor analyzes the plurality of elevator parameter records to generate a plurality of predicted parameter records contained in a predictive parameter database.

In addition to one or more of the features described above, or as an alternative, further embodiments could include that the user interface is a web based application.

In addition to one or more of the features described above, or as an alternative, further embodiments could include that the processor sorts the at least one elevator into at least one elevator group.

In addition to one or more of the features described above, or as an alternative, further embodiments could include that the at least one elevator provides at least one of the plurality of elevator parameter records via a remote communication link.

In addition to one or more of the features described above, or as an alternative, further embodiments could include that the parameter of interest records include an availability status, a load value, a door status, a hoistway position, a calendar value, an elevator availability rate, a floors served value, a stop value, a total time of operation, and a total occupancy value.

In addition to one or more of the features described above, or as an alternative, further embodiments could include that the predicted parameter records include a predicted occupancy value, a predicted availability status, a predicted load value, and a predicted hoistway position.

According to an embodiment, a method for managing at least one elevator includes storing a plurality of elevator parameter records corresponding to the at least one elevator in an elevator parameter database, analyzing the plurality of elevator parameter records via a processor, generating a plurality of parameter of interest records contained in a parameter of interest database via the processor, and displaying the plurality of parameter of interest records via a user interface.

In addition to one or more of the features described above, or as an alternative, further embodiments could include generating a plurality of predicted parameter records contained in a predictive parameter database via the processor, and displaying the plurality of predicted parameter records via a user interface.

In addition to one or more of the features described above, or as an alternative, further embodiments could include sorting the at least one elevator into at least one elevator group via the processor.

In addition to one or more of the features described above, or as an alternative, further embodiments could include providing at least one of the plurality of elevator parameter records from the at least one elevator via a remote communication link.

In addition to one or more of the features described above, or as an alternative, further embodiments could include that the parameter of interest records include an availability status, a load value, a door status, a hoistway position, a calendar value, an elevator availability rate, a floors served value, a stop value, a total time of operation, and a total occupancy value.

In addition to one or more of the features described above, or as an alternative, further embodiments could include that the predicted parameter records include a predicted occupancy value, a predicted availability status, a predicted load value, and a predicted hoistway position.

The technical function of the embodiments described above includes a processor to analyze the plurality of elevator parameter records to generate a plurality of parameter of interest records contained in a parameter of interest database, and a user interface to display the plurality of parameter of interest records.

Other aspects, features, and techniques of the embodiments will become more apparent from the following description taken in conjunction with the drawings.

### BRIEF DESCRIPTION OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the FIGURES:

FIG. 1 illustrates a schematic view of an embodiment of an elevator management system; and

FIG. 2 is a flowchart illustrating a method to manage an elevator system.

### DETAILED DESCRIPTION

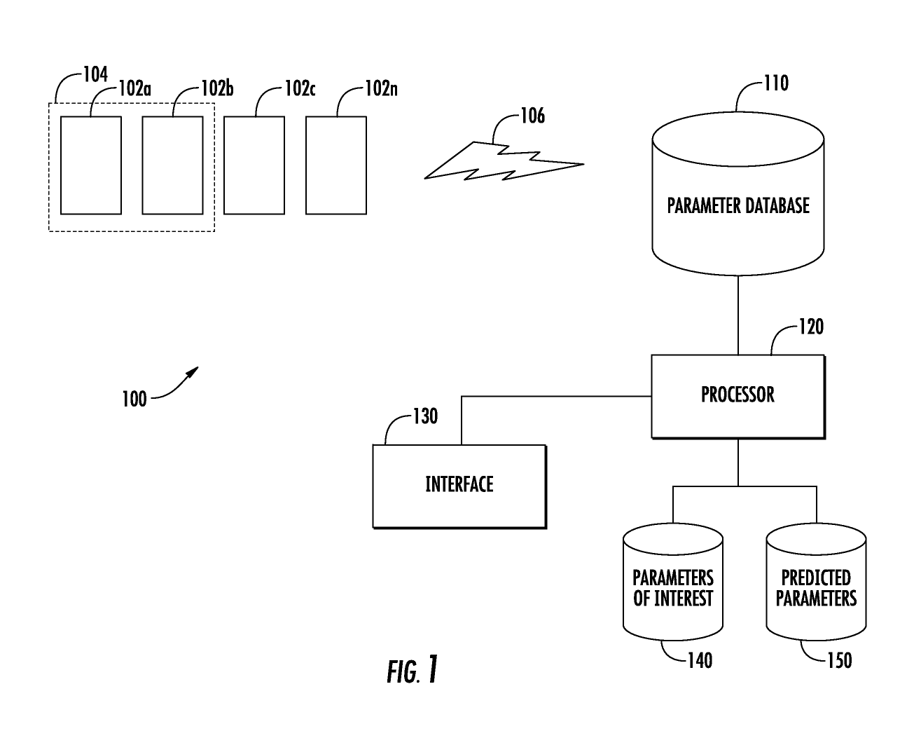

Referring to FIG. 1 an illustrated embodiment of an elevator management system 100 is shown. In the illustrated embodiment the elevator management system includes elevators 102a-102n, a parameter database 110, a processor 120, an interface 130, a parameters of interest database 140, and a predicted parameters database 150. In the illustrated embodiment, the elevator management system 100 is a centralized management system that can display elevator parameters, provide metrics, business information, and provide predictions based on empirical and entered data.

In the illustrated embodiment, a plurality of elevator cars 102a-102n are shown. In certain embodiments, the elevator management system 100 can include any suitable number of elevator cars 102a-102n. In the illustrated embodiment, the plurality of elevator cars 102a-102n can be located at a single location, building, campus, etc. In certain embodiments, the plurality of elevator cars 102a-102n can be located across multiple locations and centrally managed via the elevator management system 100. In the illustrated embodiment, the elevator cars 102a-102n can include sensors to provide relevant parameters regarding operating conditions, including loads, position, usage, etc. In certain embodiments, the elevator cars 102a-102n can be grouped into groups 104 to sort elevator cars 102a-102n that may be monitored or managed together. In certain embodiments, groups 104 can be based on location, priority, service requirements, etc.

In the illustrated embodiment, elevator car 102a-102n parameters can be transmitted to the elevator management system 100 via remote transmissions 106. In certain embodiments, individual elevator cars 102a-102n can provide remote transmissions 106 directly or via an independent control system associated with the respective elevator car 102a-102n. In certain embodiments, the remote transmissions 106 can be received by the processor 120. In certain embodiments, the remote transmissions 106 are received by the parameter database 110.

In the illustrated embodiment, the parameter database 110 stores elevator parameter records corresponding to the parameters of the elevators 102a-102n. In certain embodiments, the elevator parameter records can include an elevator identification, a time stamp and elevator parameters. In the illustrated embodiment, elevator parameters can include, but are not limited to, an elevator status, an elevator availability, an out of service status, a load value, a door status, an elevator position within the hoistway, etc.

In the illustrated embodiment, a processor 120 can analyze the data within the parameter database 110. During operation, the processor 120 can identify parameters of interest, such as exceptional events, values out of a predefined range, unexpected usage, etc. In the illustrated embodiment, the processor 120 can identify parameters of interest as parameter of interest records and store them in a parameter of interest database 140. The parameter of interest database 140 can include records that are determined by analytic methods, value comparisons with known values, unusual time stamps, comparison to historical values, etc. Advantageously, by utilizing the processor 120, certain parameter records can be identified to be easily accessed by the user via the interface 130, which provides visibility regarding potential issues within the elevator system, current elevator usage and status, etc.

Further, in certain embodiments, the processor 120 can perform statistical analysis of the elevator parameter records from the elevator parameter database 110. Advantageously, the processor 120 can summarize elevator data, determine trends, provide metrics, and otherwise provide parameters of interest to an end user. In the illustrated embodiment, the processor 120 can utilize any known statistical method to analyze the elevator parameter records. For example, the processor 120 can analyze the elevator parameter records to determine an elevator availability rate, a system availability rate, floor service trends, elevator usage trends per elevator or system wide, etc. Advantageously, statistical analysis of the elevator parameter records can provide information regarding the movement of people within a building, site, or other location. After performing such an analysis, the processor 120 can evaluate the results and identify parameters and results of interest to be stored in the parameter of interest database 140.

In the illustrated embodiment, the processor 120 can further predict elevator parameters and usage based on historical data and trends. Advantageously, by utilizing historical elevator parameters, the movement of people within a building can be anticipated based on the time of day, day of the week, seasons, etc., allowing for optimal planning and allocation of building services. Accordingly, both building management, business management, and other users can predict traffic within a building based on elevator data. In certain embodiments, the processor 120 can utilize historical information available in the parameter database 110 such as historical loads, elevator stop data, historical door statuses, etc. In the illustrated embodiment, the processor 120 can store predicted elevator parameter records in the predicted parameters database 150.

In the illustrated embodiment, the processor 120 can identify logical groups 104 of the elevators 102a-102n to organize, synthesize, or sort the information provided from the parameter database 110, the parameters of interest database 140 and the predicted parameters database 150. Advantageously, logical groups 104 can be formed based on location, usage, business impact, etc.

In the illustrated embodiment, the interface 130 can display parameters of interest from the parameter of interest database 140 and predicted parameters from the predicted parameter database 150. In certain embodiments, the interface 130 can allow access to all parameters collected by the elevator management system 100 by allowing review of the parameter database 110. In the illustrated embodiment, the interface 130 can be a centralized user interface to allow relevant historical, current, and predicted information about the elevators 102a-102n to be viewed. Advantageously, the interface 130 can provide elevator information, usage information, as well as information that impacts business decisions, such as expected traffic within a business. In the illustrated embodiment, the interface 130 can be a website or web application, while in other embodiments, the interface 130 can be a smartphone application, a cloud based application, or any other suitable interface.

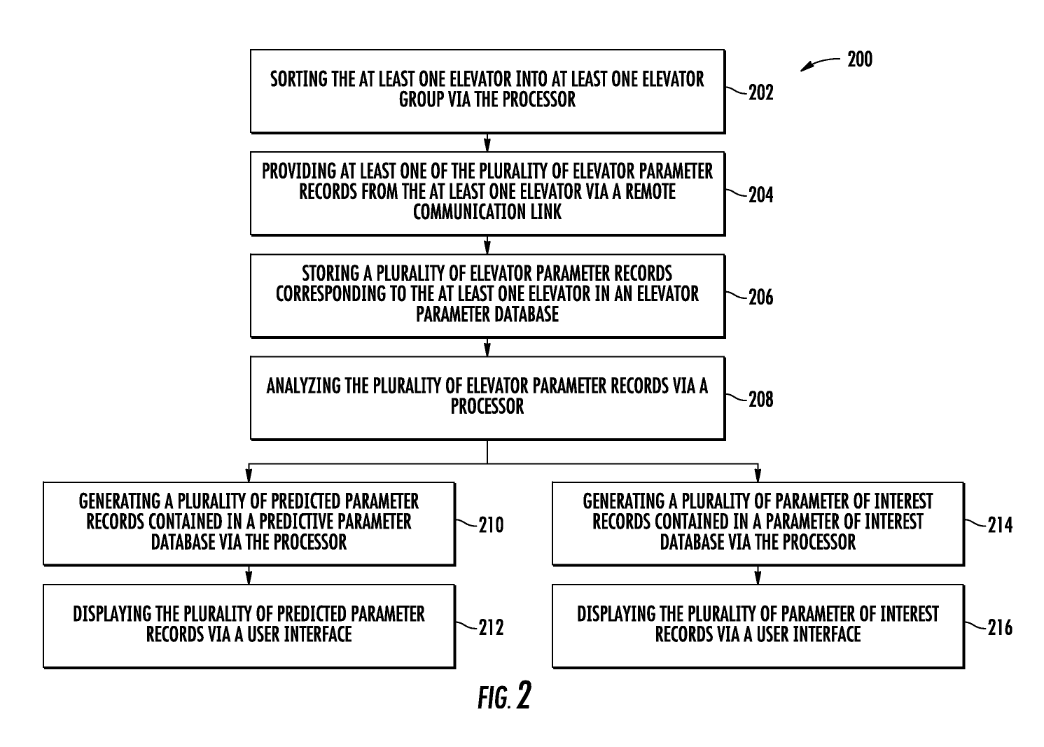

Referring to FIG. 2, a method 200 to manage an elevator system is shown. In operation 202, the at least one elevator is sorted into at least one elevator group via the processor. In certain embodiments, the elevator cars can be grouped into groups to sort elevator cars that may be monitored or managed together. In certain embodiments, groups can be based on location, priority, service requirements, etc.

In operation 204, at least one of the plurality of elevator parameter records is transmitted from the at least one elevator via a remote communication link. In certain embodiments, individual elevator cars can be provide remote transmissions directly or via an independent control system associated with the respective elevator car.

In operation 206, a plurality of elevator parameter records corresponding to the at least one elevator is stored in an elevator parameter database. In certain embodiments, the elevator parameter records can include an elevator identification, a time stamp and elevator parameters. In the illustrated embodiment, elevator parameters can include, but are not limited to, an elevator status, an elevator availability, an out of service status, a load value, a door status, an elevator position within the hoistway, etc.

In operation 208, the plurality of elevator parameter records are analyzed via a processor. During operation, the processor can identify parameters of interest, such as exceptional events, values out of a predefined range, unexpected usage, etc.

In operation 210, a plurality of predicted parameter records contained in a predictive parameter database are generated via the processor. Advantageously, by utilizing historical elevator parameters, the movement of people within a building can be anticipated based on the time of day, day of the week, seasons, etc., allowing for optimal planning and allocation of building services.

In operation 212, the plurality of predicted parameter records are displayed via a user interface.

In operation 214, a plurality of parameter of interest records contained in a parameter of interest database are generated via the processor. During operation, the processor can identify parameters of interest, such as exceptional events, values out of a predefined range, unexpected usage, etc.

In operation 216, the plurality of parameter of interest records are displayed via a user interface.

As described above, exemplary embodiments can be in the form of processor-implemented processes and devices for practicing those processes, such as processor 120. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope of the embodiments. Additionally, while various embodiments have been described, it is to be understood that aspects may include only some of the described embodiments. Accordingly, the embodiments are not to be seen as limited by the foregoing description, but are only limited by the scope of the appended claims.

1. A system for managing at least one elevator, the system comprising:
an elevator parameter database containing a plurality of elevator parameter records corresponding to the at least one elevator;
a processor to analyze the plurality of elevator parameter records to generate a plurality of parameter of interest records contained in a parameters of interest database; and
a user interface to display the plurality of parameter of interest records.

2. The system of claim 1, wherein the processor analyzes the plurality of elevator parameter records to generate a plurality of predicted parameter records contained in a predictive parameter database.

3. The system of claim 1, wherein the user interface is a web based application.

4. The system of claim 1, wherein the processor sorts the at least one elevator into at least one elevator group.

5. The system of claim 1, wherein the at least one elevator provides at least one of the plurality of elevator parameter records via a remote communication link.

6. The system of claim 1, wherein the parameter of interest records include at least one of an availability status, a load value, a door status, a hoistway position, a calendar value, an elevator availability rate, a floors served value, a stop value, a total time of operation, and a total occupancy value.

7. The system of claim 2, wherein the predicted parameter records include at least one of a predicted occupancy value, a predicted availability status, a predicted load value, and a predicted hoistway position.

8. A method for managing at least one elevator, the method comprising:
storing a plurality of elevator parameter records corresponding to the at least one elevator in an elevator parameter database;
analyzing the plurality of elevator parameter records via a processor;
generating a plurality of parameter of interest records contained in a parameter of interest database via the processor; and
displaying the plurality of parameter of interest records via a user interface.

9. The method of claim 8, further comprising:
generating a plurality of predicted parameter records contained in a predictive parameter database via the processor; and
displaying the plurality of predicted parameter records via a user interface.

10. The method of claim 8, further comprising sorting the at least one elevator into at least one elevator group via the processor.

11. The method of claim 8, further comprising providing at least one of the plurality of elevator parameter records from the at least one elevator via a remote communication link.

12. The method of claim 8, wherein the parameter of interest records include at least one of an availability status, a load value, a door status, a hoistway position, a calendar value, an elevator availability rate, a floors served value, a stop value, a total time of operation, and a total occupancy value.

13. The method of claim 10, wherein the predicted parameter records include at least one of a predicted occupancy value, a predicted availability status, a predicted load value, and a predicted hoistway position.
